(19) United States
(12) Patent Application Publication
(10) Pub. No.: US 2005/0116467 A1
(43) Pub. Date: Jun. 2, 2005

(54) Threaded member and connecting device that uses the threaded member

(76) Inventor: Hiroshi Ogawa, Iwata-shi (JP)

Correspondence Address: SMITH PATENT OFFICE, 1901 PENNSYLVANIA AVENUE N W, SUITE 200, WASHINGTON, DC, 20006, US

(21) Appl. No.: 10/992,855

(22) Filed: Nov. 22, 2004

(30) Foreign Application Priority Data
Nov. 28, 2003 (JP) P 2003-400402

(51) Int. Cl. F16J 15/00

(52) U.S. Cl. 285/86; 411/308

(57) ABSTRACT

A connecting device is formed by an internal thread and an external thread that is screwed into the internal thread and is integrally molded from synthetic resin. A protruding portion that interferes with a thread ridge of the internal thread is formed integrally with a thread bottom side of the external thread. The protruding portion is provided so that it raise a thread bottom portion in a portion of an area in the circumferential direction of the external thread, and when the two threads are screwed together, the protruding portion is shaved off or is elastically deformed by the thread ridge of the internal thread. Loosening can be avoided without intentional exterior force being applied, and suitable tightening torque can be generated consistently.

### BACKGROUND OF THE INVENTION

1. Field of the Invention

Priority is claimed on Japanese Patent Application No. 2003-400402, filed Nov. 28, 2003, the contents of which are incorporated herein by reference.

The present invention relates to a threaded member and to a connecting device that uses the threaded member. More specifically, the present invention relates to a threaded member that can be prevented from becoming loose, and that enables the torque required for tightening to be secured, and to a connecting device that uses this threaded member.

2. Description of Related Art

Conventionally, structures that are widely used in order to prevent an external thread that is screwed into an internal thread from coming loose include, for example, a structure that employs a spring washer (Conventional structure 1); a structure in which an external thread and an internal thread are fixed together using an adhesive (Conventional example 2); and a structure in which a nylon based resin material (i.e., a self-locking material) is coated on an outer peripheral surface of the external thread (Conventional example 3—see Japanese Patent Application Unexamined Publication No. 11-51032).

However, in Conventional structure 1, it is not possible to avoid any loosening unless each of the threads is tightened until the spring washer is clamped by the screw head of the external thread and the end surface of the internal thread. Moreover, it is not possible to use a spring washer when the external thread is not provided with a screw head.

In Conventional structure 2, if, after the adhesive has hardened, a large amount of torque is applied to both threads such that the adhesive is stripped away, then the adhesive can no longer operate to prevent loosening.

Furthermore, in Conventional structure 3, in addition to a separate process to coat on the resin material being required, the resin material tends to strip away from the external thread, so that, as a result, it is not possible to avoid the threads coming loose.

In this way, in Conventional structures 1 to 3, a variety of problems arise when the conventional structures are used as locking devices, and they are not suitable to be used for adjusting screws that are used in a state in which sufficient tightening torque is generated and movement in the axial direction of the external thread is restricted.

Here, the Conventional structures 4 to 6 described below are known as structures that can be used for the adjusting screw.

In Conventional structure 4, a groove-shaped receiving portion is formed in an outer circumferential surface side of an external thread, and a resin piece that has a higher height than the height of the thread ridge is inserted into the receiving portion. When the two threads are screwed together, the resin piece is elastically deformed by the thread ridge of the internal thread so as to become depressed and cut into the relevant thread ridge.

In Conventional structure 5, the minor diameter over the entire external thread is made larger than a standard size, and loosening is prevented by the apex side of the thread ridge of the internal thread being made to cut into the thread bottom of the thread groove of the internal thread.

In Conventional structure 6, the outer diameter over an entire external thread that is made from metal is made larger than a standard size, and the apex side of the thread ridge of the external thread is made to shave away the thread bottom of the thread groove of the internal thread so as to cut into it.

However, in Conventional structure 4, in addition to a separate process being required in order to insert the resin piece and thereby resulting in the manufacturing process being made more complex, the problem arises that the resin piece inadvertently falls out of the receiving portion.

Moreover, in Conventional example 5, due to unevenness in the height of the thread ridge of the internal thread and the like, the amount that this thread ridge cuts into the other thread changes, and if there is a deterioration in the machining accuracy of the internal thread, then the problem arises that the tightening torque cannot be generated consistently.

Moreover, because the minor diameter of the external thread is formed uniformly larger, when the two threads are screwed together, there is a strong tendency for the inclined surfaces forming these thread ridges to not be in contact with each other, and the thread ridges do not mesh sufficiently with each other. As a result, the thread ridges of the external thread surmount the thread ridges of the internal thread so that the external thread is easily moved in the axial direction, and the problem arises that there is a reduction in the linking force obtained from the two threads.

Furthermore, in Conventional example 6, if there is a deterioration in the machining accuracy of the internal thread, then cases can occur in which the surface area where the apex side of the thread ridge of the external thread is in close contact with the thread bottom of the internal thread is enlarged. As a result, the friction resistance between the two threads increases so that the problem arises that the tightening torque is too great.

Another example of a conventional adjusting screw will now be described with reference made to FIGS. 10A and 10B, and 11A and 11B, which adjusting screw is used with woodwind instruments such as flutes.

Woodwind instruments such as flutes, oboes and clarinets have tube bodies whose tone holes are controlled to be opened or closed by key systems being operated by players. That is, players operate the key systems to selectively open or close the tone holes by shifting tampons in position, thus producing sounds having desired pitches.

In general, there are provided two types of the key systems, namely, a close key system and an open key system. The close key system normally closes the tone holes in a non-performance mode, so it selectively opens the tone holes upon manual operations made by the player. The open key system normally opens the tone holes in a non-performance mode, so it selectively closes the tone holes upon manual operations made by the player.

The key system shown in FIGS. 10A and 10B is an open key system that normally opens the tone holes in a non-performance mode, and the key system shown in FIGS. 11A and 11B is a close key system that normally closes the tone holes in a non-performance mode.

In FIGS. 10A and 10B, a reference numeral 31 designates a tube body, 32 designates a tone hole which is formed at a selected position on an exterior periphery of the tube body 31, 33 designates a shaft that is arranged outside of the exterior periphery of the tube body 31 and is also arranged approximately in parallel with an axial line of the tube body 31, 34 designates a key pipe whose internal hole engages with the shaft 33 in a free rotation manner, and 35 designates a key cup arm that is fixed to a selected position of the key pipe 34 by braze, wherein a key cup 37 is installed on a tip end portion of the key cup arm 35. In addition, a reference numeral 36 designates a tampon that is stored in the key cup 37 and is moved to open or close the tone hole 32, and 38 designates a communicating plate that is fixed to a selected position of the shaft 33 in connection with the key cup arm 35, wherein the communicating plate 38 has a tapped hole 38a with which an adjustment screw 39 is to be engaged. The key cup arm 35 has a communicating bearing 40 to project downwardly toward a tip end of the adjustment screw 39. When the key cup arm 35 is rotated to close the tone hole 32 by the tampon 36, the adjustment screw 39 comes in contact with the communicating bearing 40 to restrict further rotation of the key cup arm 35.

In this key system, a human operator rotates the adjustment screw 39 to slightly change a contact timing at which the communicating bearing 40 comes in contact with the adjustment screw 39. Thus, the woodwind instrument is adjusted such that the tampon 36 closes the tone hole 32 in an optimal condition of closing.

On the other hand, in FIGS. 11A and 11B, which shows a close key system that normally closes tone holes in a non-performance mode, a stopper 41 is fixed to a selected position of a key pipe 34 in connection with a communicating plate 38. Herein, the stopper 41 has a tapped hole 41a with which an adjustment screw 39 is to be engaged. When a tampon closes a tone hole, a tip end of the adjustment screw 39 is pressed against the communicating plate 38 by elastic force being produced by a spring (not shown). Also in this case, a human operator rotates the adjustment screw 39 to change an angle of the stopper 41 against the communicating plate 38. Thus, a woodwind instrument installing the close key system is adjusted such that the tampon closes the tone hole in an optimal condition of closing by adjustment of the angle of the stopper 41 against the communicating plate 38.

The conventional adjustment screws of the woodwind instruments as mentioned above bear drawbacks in that the adjustment screws are loosened or released during musical performance of the woodwind instruments. So, engineers or human operators conventionally take various measures for prevention of loosening of the adjustment screws, such as that described below:

Reverting to FIGS. 10A and 10B, an end of the communicating plate 38 is partially slit to form a forked portion whose slit communicates with the tapped hole 38a with which the adjustment screw 39 is engaged. After the adjustment screw 39 is completely screwed into the tapped hole 38a, the forked portion of the communicating plate 38 is caulked so that an interior circumference of the tapped hole 38a is intensely pressed against the adjustment screw 39. Thus, frictional force (or rotation resistance) is increased between the tapped hole 38a and adjustment screw 39. The aforementioned stopper 41 in FIGS. 11A and 11B is also modified as similar to the communicating plate 38.

To such a measure, however, there is a drawback that, if a human operator strongly caulks the forked portion of the communicating plate 38 too much, it becomes impossible to further rotate the adjustment screw 39 within the tapped hole 38a. In contrast, if the human operator weakly caulks the forked portion, it is impossible to apply sufficient rotation resistance between the tapped hole 38a and adjustment screw 39 so that the adjustment screw 39 is to be easily loosened. That is, the measure bears a difficulty to set optimal rotation resistance between them.

The present invention was conceived in view of the above described problems and it is an object thereof to provide a threaded member that is easily manufactured and that enables loosening of threads to be avoided without applying intentional external force, and that also enables a tightening torque to be generated with the appropriate consistency, and also to provide a connecting device that uses this threaded member.

### SUMMARY OF THE INVENTION

In order to attain the above object, according to an aspect of the present invention, there is provided a threaded member made of synthetic resin by molding, which comprises a protruding portion formed integrally with a thread bottom side of the threaded member, wherein the protruding portion is located in a portion of an area running in a circumferential direction of the threaded member.

According to another aspect of the present invention, there is provided a connecting device which comprises a first threaded member; and a second threaded member made of synthetic resin by molding that screws together with the first threaded member, wherein the second threaded member comprises a protruding portion formed integrally with a thread bottom side thereof, which protruding portion interferes with a thread ridge of the first threaded member, and the protruding portion is located in a portion of an area running in a circumferential direction of the second threaded member.

Preferably, in the connecting device described above, if a maximium height of the protruding portion is taken as h1, and a height of the thread ridge of the first threaded member is taken as h2, then h1/h2 is set so as to be not less than 0.3 and not more than 1.0.

Preferably, in the connecting device described above, an outer surface of the protruding portion has a curved configuration whose maximum height is in a center portion in the circumferential direction thereof.

According to the present invention, if, for example, a first threaded member is an internal thread, and a second threaded member is an external thread, then a protruding portion that is formed on the external thread interferes with a portion of the thread ridge of the internal thread and is shaved off along the thread ridge configuration, or is elastically deformed. Accordingly, inclined surfaces of the thread ridges in areas of the external thread where no protruding portions are formed mesh under pressure with inclined surfaces of thread ridges of the internal thread, so that even if there is a deterioration in the accuracy of the dimensions such as the height and the like of the thread ridges of the internal thread, it is still possible to generate a consistent tightening torque. As a result, it is possible to effectively prevent loosening between the respective threads, and the threaded member can be used as an adjusting screw without any problems. Furthermore, by changing the width in the circumferential direction of the protruding portion and its height, the magnitude of the tightening torque to be generated can be adjusted, and consistent tightening torque can be achieved as a result of this as well. Because the meshing of the thread ridges is maintained in an excellent condition, it is possible to solve such problems as those in Conventional structure 5, and maintain an excellent connecting force between the threads. Moreover, because the protruding portion is formed integrally with the thread bottom side, not only can the problem of the protruding portion dropping from the external thread be solved, but the protruding portion can be manufactured with ease and precision using a mold or the like.

Furthermore, because the outer surface of the projecting portion is formed as a curved surface, in an initial state in which the projecting portion is made to interfere with the thread ridge of the second threaded member, it is possible to reduce the resistance caused by this interference, and each threaded member can be rotated smoothly relative to the other member and the two members thereby screwed together.

### BRIEF DESCRIPTION OF THE DRAWINGS

FIG. 1 is a schematic front view of a connecting device according to an embodiment of the present invention.

FIG. 2 is a plan view of FIG. 1.

FIG. 3 is an enlarged front cross-sectional view of an A portion and a B portion in FIG. 1.

FIG. 4 is an enlarged end view taken along a line C-C in FIG. 1.

FIG. 5 is an enlarged front cross-sectional view of a state in which an external thread is screwed together with an internal thread.

FIG. 6 is the same end view as in FIG. 4 of an external thread according to a variant example.

FIG. 7 is the same end view as in FIG. 4 of an external thread according to another variant example.

FIG. 8 is a front view of an external thread according to yet another variant example.

FIG. 9 is a perspective view of an adjustment screw, shown with selected parts of a woodwind instrument, for use in adjustment of closing of a tone hole of the woodwind instrument by a close key system according to an embodiment of the present invention.

FIG. 10A is an enlarged view partly in section of selected parts of a woodwind instrument including a conventional adjustment screw for adjustment on closing of a tone hole by a tampon by an open key system.

FIG. 10B is a plan view of some parts of the woodwind instrument shown in FIG. 10A.

FIG. 11A is an enlarged view partly in section of selected parts of a woodwind instrument including a conventional adjustment screw for adjustment on closing of a tone hole by a tampon by a close key system.

FIG. 11B is a plan view of some parts of the close key system shown in FIG. 11A.

### DETAILED DESCRIPTION OF THE INVENTION

Embodiments of the present invention will now be described with reference made to the drawings.

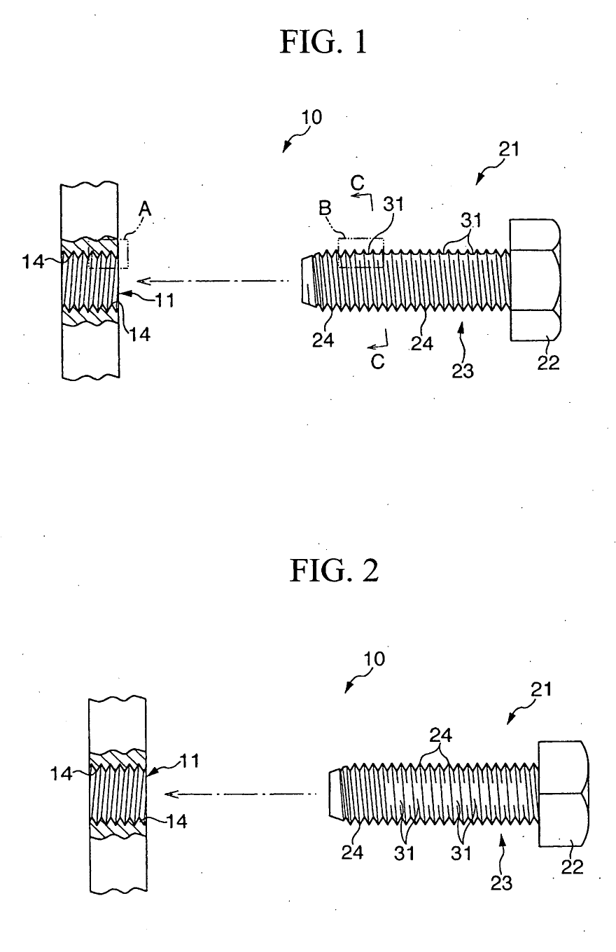

FIG. 1 is a schematic front view of a connecting device according to the present invention, while FIG. 2 is a plan view of FIG. 1. In these figures, a connecting device 10 is constructed by an internal thread 11 as a first threaded member that is positioned at the left side in FIG. 1, and an external thread 21 as a second threaded member that is positioned at the right side in FIG. 1 and that is screwed together with the internal thread 11.

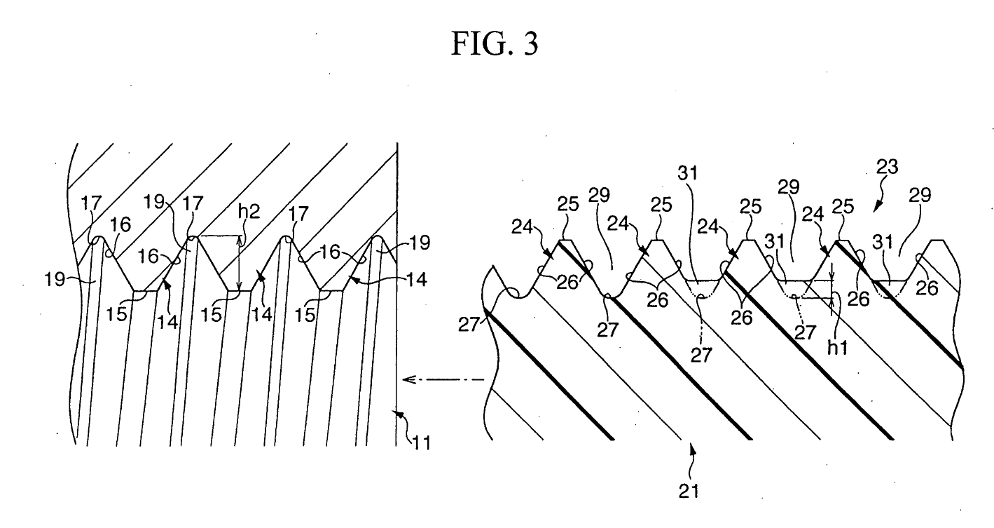

The internal thread 11 is formed in the same way as a known thread of JIS standard or the like and, in the present embodiment, is formed by performing threaded hole processing on a plate shaped member formed from a metal such as nickel silver or brass. When the internal thread 11 is seen in cross section, as is shown in FIG. 3, a plurality of thread ridges 14 are provided in the center axial direction thereof, and each thread ridge 14 is formed so as to protrude towards the center axis of the internal thread 11. The thread ridges 14 have a configuration that is provided with an apex portion 15, inclined surface portions 16 that are connected to both the left and right end sides as seen in FIG. 3 of the apex portions 15 and are formed in a gradually widening fan shape, and a thread bottom portion 17 that connects together base sides of each inclined surface portion 16 of adjacent thread ridges 14. Thread grooves 19 are formed respectively between each thread ridge 14.

In the present embodiment, the external thread 21 is formed by a hexagonal bolt that is molded using a molding process such as. injection molding or the like using a synthetic resin having a lower degree of hardness than the internal thread 11 such as a nylon based resin into which glass fibers have been mixed as a reinforcing material. The external thread 21 is formed by a screw head 22 and a screw shaft 23 that is joined to the screw head 22 and that is shaped such that the distal end side thereof gradually tapers. When seen in cross section, as is shown in FIG. 3, the screw shaft 23 is provided with a plurality of thread ridges 24 that protrude outwards. The thread ridges 24 are configured such that the direction of protrusion of the thread ridges 14 of the internal thread 11 is reversed, and, in the same way as for the thread ridges 14 of the internal thread 11, the thread ridges 24 are provided with an apex portion 25, inclined surface portions 26, and a thread bottom portion 27. Thread grooves 29 are formed respectively between each thread ridge 24.

Here, a plurality of protruding portions 31 that are formed so as to raise up the thread bottom portions 27 are provided integrally with a portion of an area on the thread bottom portion 27 side that runs in the circumferential direction of the screw shaft 23.

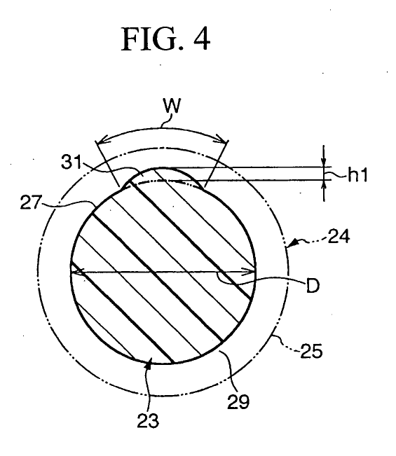

Each of the protruding portions 31 is provided at a top end side as seen in FIG. 1 of the screw shaft 23, and is formed so as to run in the axial direction towards the screw head 22 side from a position separated by a plurality of pitches from the distal end of the screw shaft 23. As is shown in FIG. 4, central portions in the circumferential direction of the outer surfaces of the protruding portions 31 are provided in a substantially barrel-shaped curved surface configuration having a maximum height of h1. The maximum height h1 is set so as to fall within the range of the following formula when the height of the thread ridges 14 of the internal thread 11 is taken as h2 (see FIG. 3).
0.3≦(h1/h2)≦1.0

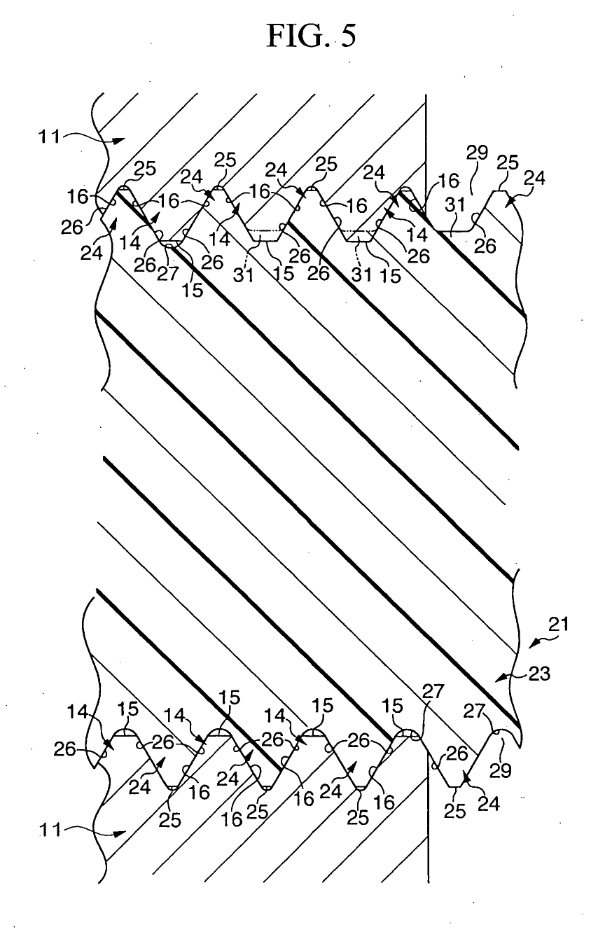

From this, as is shown in FIG. 5, when the internal thread 11 is screwed together with the external thread 21, the protruding portions 31 interfere with the apex portion 15 side of the thread ridges 14 of the internal threads 11, and because of this interference, even without any force being applied, the protruding portions 31 are shaved off along the configuration of the thread ridges 14 or are elastically deformed, so that inadvertent loosening of the threads 11 and 21 is prevented. If h1/h2 is less than 0.3, then due to dimensional errors in the internal thread 11 and the like, there is a possibility that the thread ridges of the internal thread 11 will no longer interfere. In contrast, if h1/h2 is greater than 1.0, then it is difficult to insert the screw shaft 23 of the external thread 21 inside the internal thread 11, and the tightening torque only increases by the amount of the increase in the shaved off portion of the protruding portion 31. The effect of preventing loosening after the protruding portions 31 have been shaved off, however, is constant. Note that h1 and h2 are preferably set within the following range.
0.8≦(h1/h2)≦1.0

Moreover, the width W in the circumferential direction of the protruding portions 31 is set so as to fall within the range of the following formula for a diameter D (i.e., a minor diameter) on the bottom portion 27 side of the external thread 21.
0.3≦(W/D)≦(π/2)

By changing the width W within this range, the friction resistance between the apex portions 15 and the protruding portions 31 can be increased or decreased, and it is possible to adjust the tightening torque of the external thread 21.

In the structure described above, when the internal thread 11 is screwed together with the external thread 21, after the distal end side of the screw shaft 23 has been inserted into the internal thread 11, it is sufficient if tightening torque is applied to the external thread 21 via the screw head 22. At this time, the apex portion 15 of the thread ridges 14 of the internal thread 11 interferes with the protruding portions 31, and, as is shown in FIG. 5, the protruding portions 31 are elastically deformed or shaved off by the apex portion 15 of the thread ridges 14 of the internal thread 11. The apex portion 15 of the thread ridges 14 then bites into the protruding portions 31. In this condition, in areas where the protruding portions 31 of the external thread 21 are not formed, in particular, on the opposite side in the radial direction from the position where the protruding portions 31 are formed, the inclined surfaces 26 of the external thread 21 are pressed by the inclined surfaces 16 of the internal thread 11. As a result, the adhesion between the two is increased, and it becomes possible to generate appropriate tightening torque.

Consequently, according to this embodiment, because the protruding portions 31 are provided integrally in the axial direction of the external thread 21, then in a state in which the protruding portions 31 interfere with the thread ridges 14 of the internal thread 11, even if the external thread 21 is tightened or, conversely, loosened, a sufficient tightening torque can still be secured, and it can be used as an adjustment screw whose movement in the axial direction of the external thread 21 is consistently restricted.

In addition, because the distal end of the screw shaft 23 has a tapered configuration, the screw shaft 23 can be inserted without force inside the internal thread 11. Furthermore, because the protruding portions 31 are not formed in an area several pitches from the distal end of the screw shaft 23, this area acts as a guide for rotating the external thread 21, in a state in which the tightening torque of the external thread 21 is extremely small, until the protruding portions 31 interfere with the thread ridges 14 of the internal thread 11.

Moreover, because the protruding portions 31 are formed in a portion of an area running in the circumferential direction of the external thread 21, when the protruding portions 31 are deformed or the like, the thread grooves 29 on both sides in the circumferential direction of the protruding portions 31 (i.e., on both the left and right sides in FIG. 4) act as deformation tabs, and it is possible to reduce the internal stress at the circumference of the protruding portions 31 so that they can be deformed without using excessive force.

The optimum structure and method and the like in order to implement the present invention have been disclosed in the above description, however, the present invention is not limited to these.

Namely, the present invention is described and, in particular, illustrated in relation to a specific embodiment, however, those skilled in the art may make various alterations in the configuration, position, direction, or other detailed structure of the above embodiment without departing from the technical concept and object of the present invention.

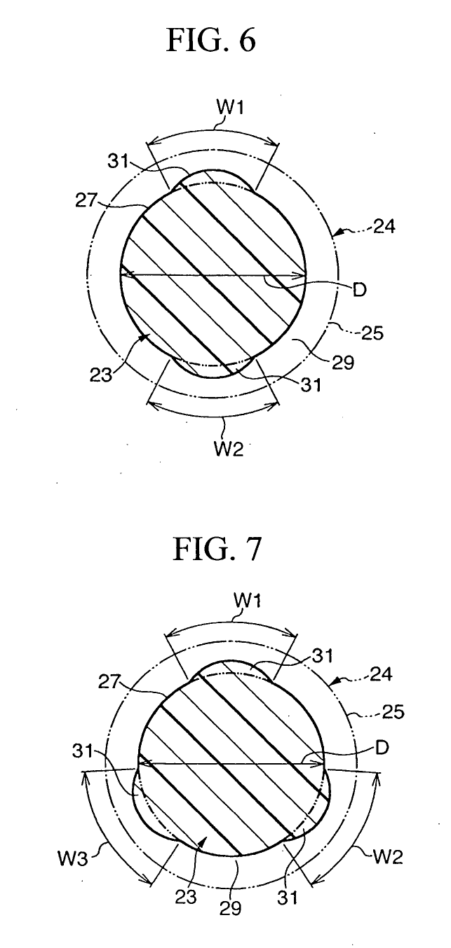

For example, in the embodiment, as is shown in FIG. 3, the protruding portions 31 are provided at one position in the circumferential direction of the screw shaft portion 23, however, as is shown in FIGS. 6 and 7, it is also possible to employ a structure in which they are provided at intervals of approximately 180 degrees or 120 degrees in this circumferential direction. At this time, the sum of the widths of the respective protruding portions 31 (i.e., W1+W2=W in the structure shown in FIG. 6, while W1+W2+W3=W in the structure shown in FIG. 7) is set so as to be within the range given below.
0.3≦(W/D)≦(π/2)

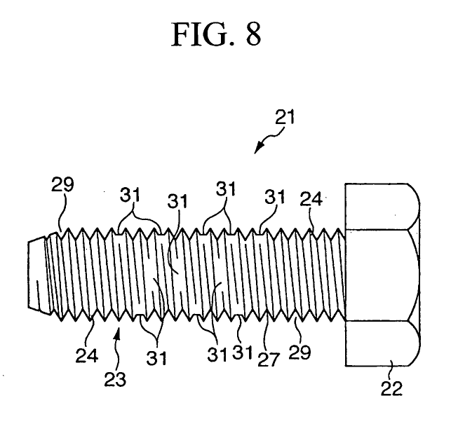

It is also possible to employ a structure in which, as is shown in FIG. 8, a plurality of the protruding portions 31 are provided so as to be non-continuous in a direction in which the grooves 29, which extend in a spiral shape, extend.

Moreover, a description and illustrations are given of when the protruding portions 31 are provided on the external thread 21, however, the present invention is not limited to this and a design modification using a structure in which the protruding portions 31 are provided on the thread bottom portions 17 of the internal thread 11 is also possible. At this time, the maximum height of the protruding portions 31 is set using the above described relationship with the height of the thread ridges 24 of the external thread 21, instead of the height h2 of the thread ridges 14 of the internal thread 11. In addition, while the internal thread 11 is made from synthetic resin, the external thread 21 is made from metal.

Furthermore, in the above embodiment, the first threaded member is the internal thread 11, which is formed by machining a hole in a plate-shaped member, however, it may also be formed by a nut member such as a hexagonal nut. In addition, the second threaded member is not limited to a hexagonal bolt, and may also be formed by a threaded member having a screw head 22 in which a hole or slit is formed for inserting a screwdriver, or may also be formed by a setscrew type of screw in which no screw head 22 is provided.

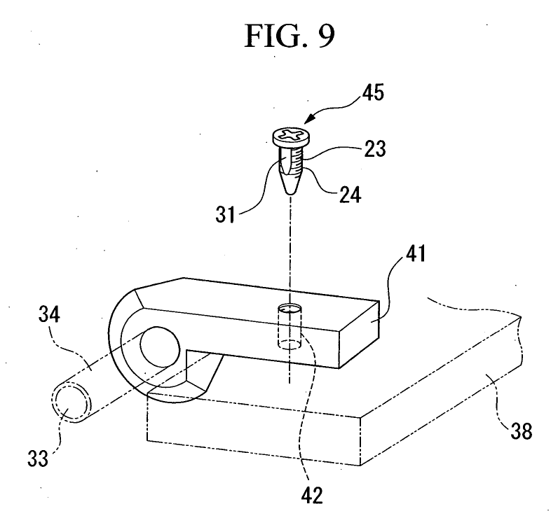

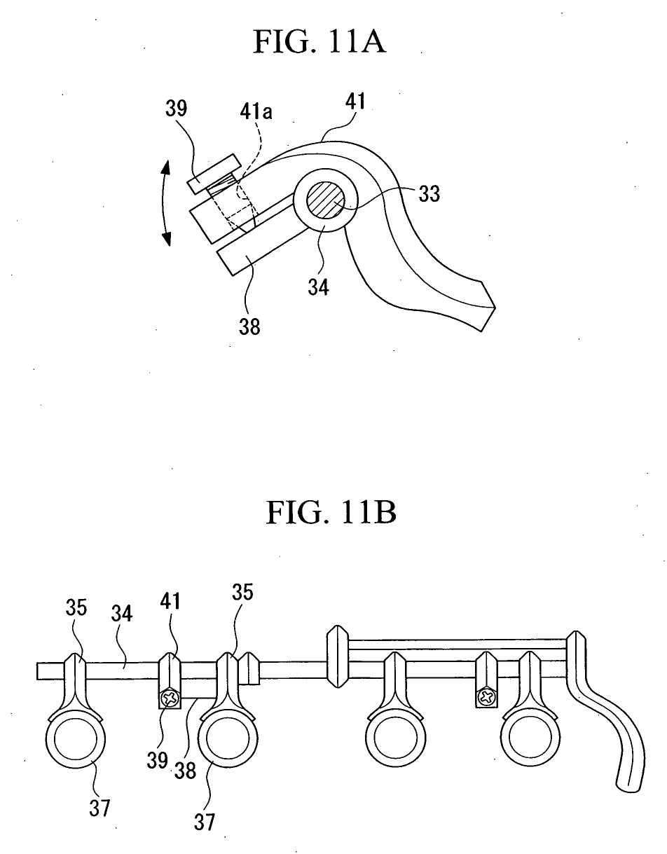

An example of application of an adjusting screw according to the present invention to adjustment of closing tone holes of woodwind instruments such as flutes will now be described with reference made to FIG. 9. In this embodiment, the adjusting screw is applied to a close key system that normally closes tone holes of a tube body of a woodwind instrument. In FIG. 9, parts identical to those shown in FIGS. 11A and 11B are designated by the same reference numerals, hence, the description thereof will be omitted to avoid repetition of explanation.

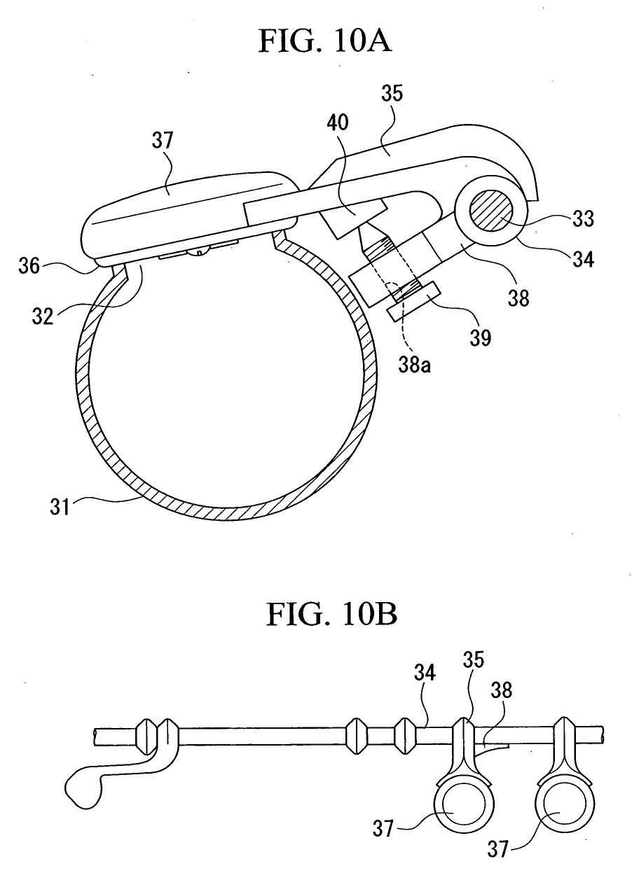

A communicating plate 38 is fixed to a shaft 33, which is attached to an exterior periphery of a tube body of the woodwind instrument (i.e., flute), by braze or solder. In addition, an internal hole of a key pipe 34 engages with the shaft 33 in a free rotation manner. Further, a stopper 41 (namely, a screw fixing member) is fixed to the key pipe 34 and is placed opposite to the communicating plate 38. A not-shown tampon is attached to a not-shown opposite end of the stopper 41 that opens or closes a tone hole. Designated 45 is an adjusting screw and 42 is a screw hole that screws with the adjusting screw 45. In this close key system, as is the case with the key systems shown in FIGS. 10A to 11B, a human operator rotates the adjustment screw 45 to change an angle of the stopper 41 against the communicating plate 38. Thus, a woodwind instrument installing the close key system is adjusted such that the tampon closes the tone hole in an optimal condition of closing by adjustment of the angle of the stopper 41 against the communicating plate 38.

Here, the adjustment screw 45 is comprised of the external thread 21 in the preceding embodiments, and the screw hole 42 is comprised of the internal thread 11 in the preceding embodiments. Thus, the adjustment screw 45 (external thread 21) includes a screw shaft 23, a plurality of thread ridges 24, and a plurality of protruding portions 31 provided so as to raise up the thread bottom portions 27 of the external thread 21 and provided integrally with a portion of an area on the thread bottom portion 27 side that runs in the circumferential direction of the screw shaft 23 (FIGS. 1 to 5). The thread ridges 14 of the internal thread 11 protrude reversely to the thread ridges 24 of the external thread 21.

From this, as described with reference to FIG. 5, when the screw hole 42 is screwed together with the adjustment screw 45, the protruding portions 31 interfere with the apex portion 15 side of the thread ridges 14 of the internal threads 11, and because of this interference, the protruding portions 31 are shaved off along the configuration of the thread ridges 14 or are elastically deformed, so that inadvertent loosening of the threads 11 and 21 is prevented.

Furthermore, although in the previous embodiment a description and illustration have been given of when the adjustment screw 45 of the present invention is applied to the close key system, the adjustment screw of the present invention is also applicable to the open key system as shown in FIGS. 10A and 10B.

Moreover, an adjustment screw in which the protruding portions 31 are provided on the thread bottom portions 17 of the internal thread 11 is also usable as an adjustment screw for woodwind instruments.

The present invention can be used to join two different members together and can be used as an adjusting screw.

The present invention can also be used as an adjusting screw for use with woodwind instruments.

1. A threaded member made of synthetic resin by molding, comprising:
a protruding portion formed integrally with a thread bottom side of the threaded member, wherein
the protruding portion is located in a portion of an area running in a circumferential direction of the threaded member.

2. A connecting device comprising:
a first threaded member; and
a second threaded member made of synthetic resin by molding that screws together with the first threaded member, wherein
the second threaded member comprises a protruding portion formed integrally with a thread bottom side thereof, which protruding portion interferes with a thread ridge of the first threaded member, and
the protruding portion is located in a portion of an area running in a circumferential direction of the second threaded member.

3. The connecting device according to claim 2, wherein if a maximum height of the protruding portion is taken as h1, and a height of the thread ridge of the first threaded member is taken as h2, then h1/h2 is set so as to be not less than 0.3 and not more than 1.0.

4. The connecting device according to claim 2, wherein an outer surface of the protruding portion has a curved configuration whose maximum height is in a center portion in the circumferential direction thereof.

5. A woodwind instrument comprising the connecting device according to claim 2.

6. The connecting device according to claim 3, wherein an outer surface of the protruding portion has a curved configuration whose maximum height is in a center portion in the circumferential direction thereof.
